(19) United States
(12) Patent Application Publication
(10) Pub. No.: US 2018/0205128 A1
(43) Pub. Date: Jul. 19, 2018

(54) METHOD OF MANUFACTURING COMPONENT FOR RF FILTER, COMPONENT, AND RF FILTER

(71) Applicant: TONGYU TECHNOLOGY OY, Espoo (FI)

(72) Inventors: Tero KÄMÄRÄINEN, Tupos (FI); Jyrki TAPANI, Oulu (FI); Marko MÄÄTTÄ, Oulunsalo (FI)

(21) Appl. No.: 15/743,788

(22) PCT Filed: Jun. 27, 2016
(86) PCT No.: PCT/FI2016/050464

§ 371 Date: Jan. 11, 2018

(30) Foreign Application Priority Data
Jul. 20, 2015 (FI) 20155562

(51) Int. Cl. H01P 1/205; H01P 11/00; C23F 1/02

(52) U.S. Cl. CPC H01P 1/2053; C23F 1/02; H01P 11/007

(57) ABSTRACT

The invention relates to a method of manufacturing a component for an RF filter, to a component for an RF filter, and to an RF filter. The method comprises forming from a sheet metal piece a component (TL, B, T) comprising an edge (ED1, ED2, TLE, HC1, HC2, HES) in the component. In the invention, in order to reduce intermodulation problems, the edge of the component is treated by etching.

### BACKGROUND OF THE INVENTION

The invention relates to a method of manufacturing a component for an RF filter, to a component, and to an RF filter.

RF filters, i.e. radio frequency filters, are used in connection with RF devices, such as transmitters, receivers or transceivers, used in base stations of mobile phone networks, for example, in particular in the amplifiers therein as filtering and adapting circuits.

Resonator type filters comprise a casing structure with one or more compartments whose shape is defined by the wall structure of the casing structure.

Typically, a compartment of the casing structure may contain an inner conductor, referred to as a resonator or a resonator pin, attached to the bottom of the compartment or cavity, a common structure being a coaxial resonator in which the inner conductor, or the resonator, shares a common axis, i.e. is coaxial, with the surrounding compartment or cavity. A compartment in a metal casing and a metallic inner conductor together form a resonant circuit. In more complex high frequency filters in particular, the casing structure consists of a plurality of compartments, each compartment having a separate inner conductor, or resonator, whereby a plural number of resonant circuits is formed and, with a suitable intercoupling of these, desired frequency responses, i.e. stopbands and passbands, are obtained.

Known methods and filter components and, thus, filters as well are such that the edges of the RF filter component, like the edges of openings in a cover or a bottom or, for instance, the edges of a transmission line, remain uneven due to limitations in manufacturing techniques that leave bursts, residue, grooves or other irregularities in the edge of the component. Such irregularities, in turn, cause intermodulation problems, that is, IM problems or PIM (Passive Intermodulation) problems, which deteriorates filter performance by deteriorating the maintenance of a frequency response as desired.

### BRIEF DESCRIPTION OF THE INVENTION

An object of the invention is thus to provide a method of manufacturing a component for an RF filter, a component, and an RF filter so as to enable the aforementioned problems to be solved or alleviated.

The object of the invention is achieved by a method of manufacturing a component for an RF filter, a component, and an RF filter which are characterised by what is disclosed in the independent claims. Preferred embodiments of the invention are disclosed in the dependent claims.

The advantage provided by the invention is a decrease in intermodulation problems, more efficient production on account of a higher yield, and good manufacturing technology properties.

### BRIEF DESCRIPTION OF THE FIGURES

The invention is now described in closer detail in connection with some embodiments and with reference to the accompanying drawings, in which:

FIG. 1 is a top view of an RF filter as seen from the direction of a cover of a casing,

FIG. 2 is a side view of an RF filter as seen from the direction of a frontmost long side of the casing,

FIG. 3 is a front diagonal view of the filter with no cover and no frontmost side,

FIG. 4 shows the filter of FIG. 3 with the cover and the frontmost side,

FIGS. 5 to 6 show an edge of a transmission line before and after etching,

FIGS. 7 to 8 show an edge surface outlining a through hole in a bottom before and after etching, and

FIG. 9 shows the transmission line with its projecting branches.

### DETAILED DESCRIPTION OF THE INVENTION

First, a filter F and some of its components will be discussed.

With reference to the figures, an RF filter F is disclosed, which filter F may be used in connection with or coupled to an RF device, such as a transmitter, a receiver, a transceiver or an amplifier. The RF device may be a radio unit of a base station in a cellular radio network or a module thereof, for example.

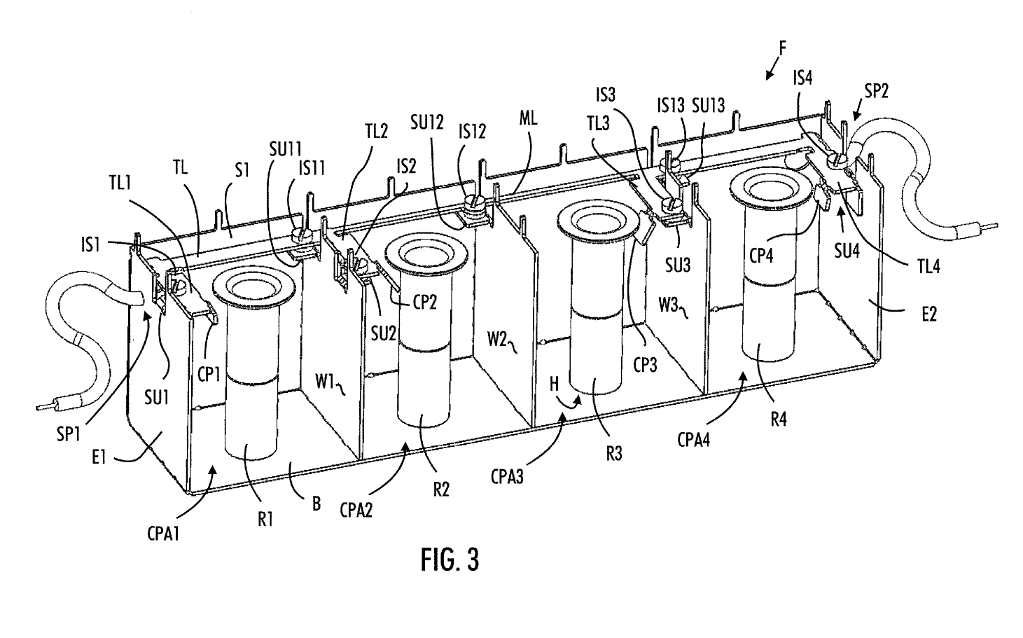

The filter F has signal ports SP1, SP2, to which a connection may be made by cables that connect the filter F to an antenna and, for example, to a transceiver. The short cables shown in FIG. 3 by the signal ports SP1, SP2 may connect the filter to coaxial connectors mounted on the walls of the outer casing (not shown) surrounding it.

The filter comprises a casing structure C which has a wall structure W and under it, a bottom B, and on top of it, a cover T. The casing structure C, that is, its wall structure W, bottom B, and cover T, are made of conductive metal, such as copper or aluminium coated with, for example, silver or another material that improves conductivity.

The RF filter shown in the figures is a coaxial resonator filter, in other words, it has one or more compartments CPA1 to CPA4 and therein correspondingly compartment-specifically inner conductors R1 to R4 or resonators, that is, resonator rods which are rectilinear, that is, coaxial with the direction in which the compartment of the casing C extends, i.e. they thus extend in the perpendicular direction between the cover and the bottom. Each cavity CPA1 to CPA4 of the casing together with its resonator R1 to R4 forms a resonant circuit, and adjacent resonant circuits together form a filter with the desired attenuation graph. The filter may be a bandpass filter, for example. The resonators R1 to R4 are fixed to the bottom B of the casing C with screws.

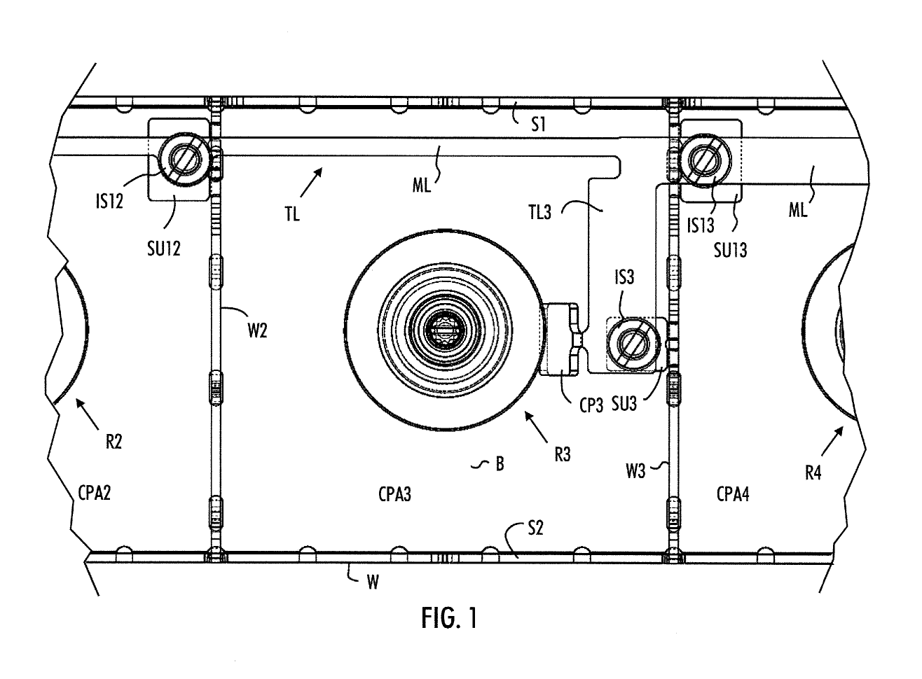

The bottom ends of the resonators R1 to R4 , i.e. the bottom parts of the resonators in FIG. 1, are thus short-circuited to the bottom B of the casing C, the bottom acting at the same time as a common ground for the resonators R1 to R4. In FIG. 1, the top parts of the resonators R1 to R4 are so-called free ends, which are galvanically separated from the casing C, particularly from the cover T of the casing. In the situation of the type shown in FIG. 1, the length of the resonators is approximately quarter-wave long.

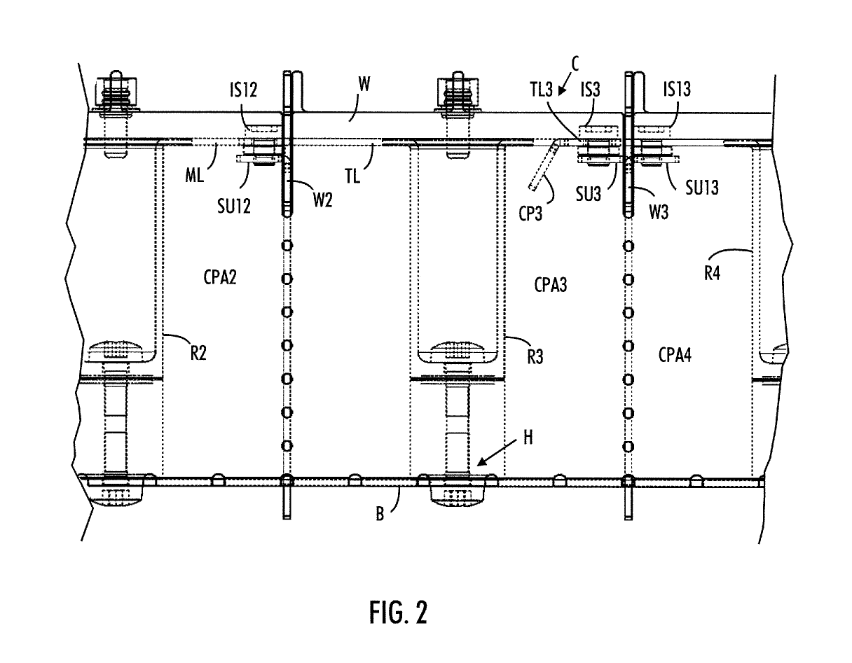

The wall structure comprised by the casing C, which is thus between the bottom B and the cover T, comprises sides S1 to S2, ends El to E2, and separating walls W1 to W3 between the compartments. A four-compartment casing structure thus has three separating walls W1, W2, W3 between the compartments CPA1, CPA2, CPA3, CPA4, the role of the separating walls being to separate the compartments and consequently the resonant circuits from one another by preventing excessive capacitive coupling between the free ends of the resonators R1 to R4. In FIG. 2, the frontmost long side S2 of the wall structure W of the casing C is closest to the viewer, so the structures seen behind the side S2 are illustrated in dotted line.

The filter comprises a signal port SP1 at an end E1 of the casing, and an RF transmission line TL connected to the signal port, the RF transmission line TL being arranged to transmit an RF signal to the compartments CPA1 to CPA4 of the RF filter. At a second end E2 of the filter, the filter comprises a second signal port SP2. The signal port SP1 may be connected to an RX//TX device, that is, a transceiver, in particular to the amplifier included therein. The signal port SP2 may be connected to an antenna cable. The other end of the transmission line TL, that is, the right-hand side end in FIG. 3, is connected to the second signal port SP2.

The transmission line TL is supported to the wall structure of the casing C. In order to support the RF transmission line TL, the wall structure of the casing C comprises a supporting bracket SU1 to SU4 which is bent from a wall of the wall structure W and to which the transmission line TL is fixed by means of an insulating mounting IS1 to IS4. FIG. 3 shows supporting brackets SU1 to SU4 bent from a wall, which are provided for projecting branches TL1 to TL4 that branch off from the main line ML of the transmission line TL. In particular, a supporting bracket, such as SU1 to SU4, bent from a wall is a supporting bracket for supporting the free end of a projecting branch SU1 to

SU4 branching off from the main line of the transmission line, because the free end of the projecting branch is the most susceptible to vibration, which might result in a change in the frequency response of the filter. In FIG. 3, the bent supporting bracket SU4 for the most part remains invisible behind the projecting branch TL4 of the transmission line TL.

The supporting brackets SU11 to SU13 bent from a wall are provided for supporting the main line ML of the transmission line TL. The transmission line TL, in particular its main line ML, is fixed to these bent supporting brackets SU11 to SU13 by means of an insulating mounting IS11 to IS13.

The projecting branches TL1 to TL4 that extend closer to the resonators R1 to R4 from the main line ML of the transmission line TL may be considered as coupling projections by means of which the capacitive coupling between the resonators R1 to R4 and the transmission line TL takes place.

The manufacturing method relates to the manufacture of components, such as a cover T, a bottom B or a transmission line TL, for an RF filter so as to enable the components to be made such that they do not cause problems in terms of intermodulation, that is, the purpose is to avoid a PIM (Passive Intermodulation) problem. The most important part is the finishing, that is, treatment by etching such that edges, such as edge sides ED1, ED2 of outer edges of the component, that are too sharp are rounded/evened out and/or such that edges HC1, HC2 of holes H, H1 of the components or edge surfaces HES of the holes are evened out. The etching may be either applied to a separate component, which will later be integrated into the RF filter while assembling the RF filter, or the etching may be applied to an already assembled filter wherein the components, such as TL, B, T, constitute the filter.

A component may thus be completed either as a separate piece, that is, both an initial stage, such as cutting off the transmission line from the sheet metal or perforating the sheet metal, and also a final stage, that is, etching, are performed on a separate component, or, alternatively, such that the initial stage is performed on a separate component but the final stage, that is, etching, is applied to an assembled RF filter containing such one or more components to be etched.

The method in question is thus a method of manufacturing a component for an RF filter, the method comprising forming from a sheet metal piece a component comprising an edge in the component. The sheet metal may be for instance sheet copper having a thickness of 1 to 5 mm, for example. This initial stage may be carried out for instance by machining, striking or laser cutting. In order to reduce intermodulation problems, the edge of the component TL, B, T is treated by etching. The sheet metal may be for instance sheet copper having a thickness of 1 to 5 mm, for example. If also the final part, that is, a second stage, is directed to a separate component, in a preferred embodiment, then, in order to treat the edge of the component TL, B, T, the component is immersed in etching liquid. The immersion may take place in an etching basin, for instance. Some feasible etching liquids include Na₂S₂O₈ or FeCl₃. According to the Applicant's observations, a suitable etching time is 1 to 30 minutes, depending on the thickness of the material and the amount of rounding required and the manufacturing process and its conditions. Instead of immersion, the treatment may be steam etching or spray etching. By etching the edge of the component, one or more of the following are removed: excessive sharpness in the edge, bursts in the edge or other irregularities in the edge. In other words, the purpose is to round a sharp edge by etching and/or even out irregularities in an edge, or in a surface formed by an edge, by etching.

In an embodiment, the component to be treated by etching is a transmission line TL for an RF filter F. In such a case, the edge of the component to be etched is an edge side or an edge surface of an outer edge of the component. Referring to FIGS. 5 to 6, the edge sides ED1, ED2 of the transmission line TL are etched to be more rounded, that is, the sharpness of the edge side is removed and, likewise, the edge surface TLE has been made more even by etching. FIG. 6 illustrates the rounding of the edge sides, as compared with FIG. 5. FIGS. 5 to 6 are views from the direction of a narrow end of the transmission line TL, as seen in the longitudinal direction of the transmission line.

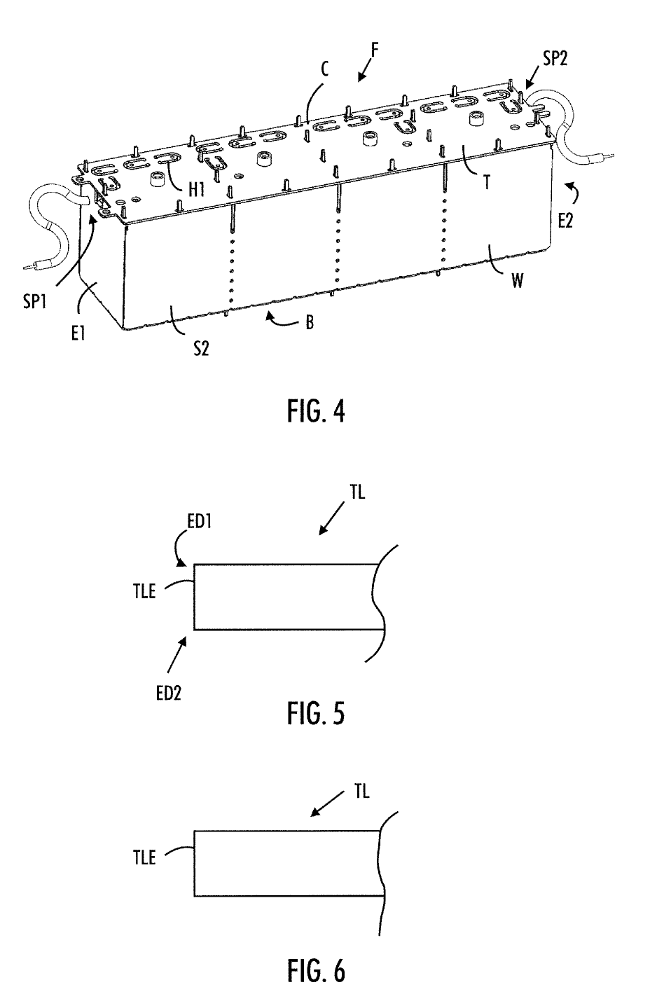

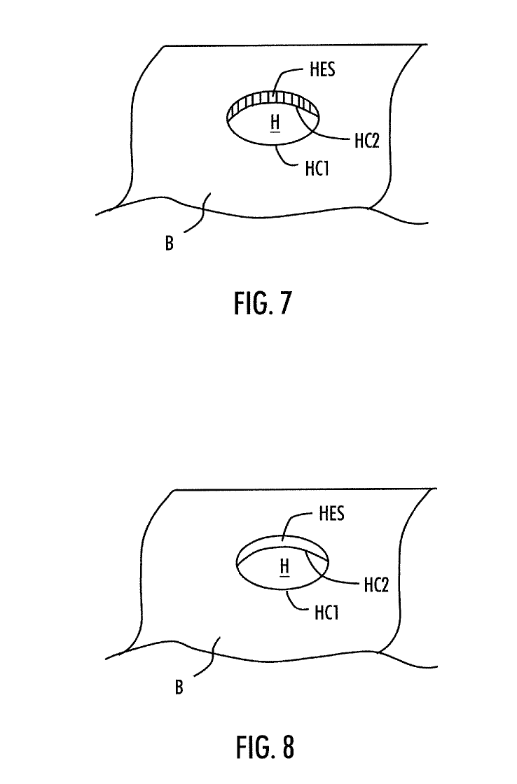

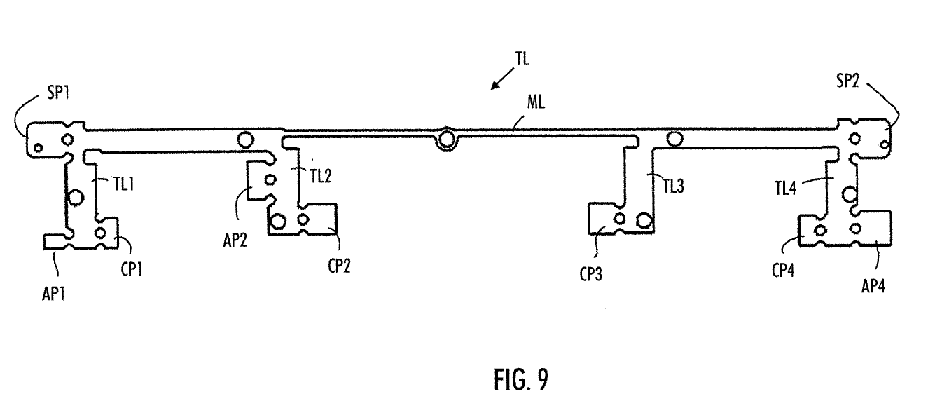

Referring particularly to FIGS. 7 to 8, instead of or in addition to the transmission line TL, the component to be treated by etching is a cover (T in FIG. 1) or a bottom B for an RF filter. In such a case, the edge of the component is an edge rim HC1, HC2 outlining a through hole H located within the area of the component, or an edge surface HES of the through hole between the edge rims HC1, HC2 of the through hole H in the component B around the through hole H. FIG. 8 illustrates the evening out of the edge surface HES of the through hole H, as compared with FIG. 7. Also the edge rims HC1, HC2 have become more rounded in the etching. In an embodiment, the through hole H treated by etching and comprising the edge surface HES forms a fastening point for a resonator (or a fastening member thereof) of a filter, such as for the resonator R3 in FIGS. 2 to 3. In FIG. 4, the hole HI of the cover T may be a slot defining the location and shape of a control member, such as a bendable control member, such as a frequency control member.

After etching, the component and/or the RF filter comprising the component are cleaned. In an embodiment, the cleaning is carried out as ultrasound cleaning.

As already discussed above, instead of a separate component, the etching may be applied to one or more components B, T, TL in an already assembled RF filter F. In such a case, in order to treat the edge, such as TLE, of the component, the component is immersed in etching liquid by immersing the RF filter F comprising the component in the etching liquid. In this version, the etching is at the same time applied to all components that are desired to be subjected to etching, but penetrability of the etching process in an already assembled filter and cleaning after the etching phase make up a more demanding procedure than that of etching and cleaning a separate component. Instead of immersion, the treatment may be steam etching or spray etching. Thus, at a general level, in order to treat the edge of the component TL, B, T, the RF filter F comprising the component T, L, B is treated by etching.

A person skilled in the art will find it obvious that, as technology advances, the basic idea of the invention may be implemented in many different ways. The invention and its embodiments are thus not restricted to the above-described examples but may vary within the scope of the claims.

1. A method of manufacturing a component for an RF filter, the method comprising forming from a sheet metal piece a component comprising an edge in the component, wherein in order to reduce intermodulation problems, the edge of the formed component is finishing-treated by etching.

2. A method as claimed in claim 1, wherein in order to finishing-treat the edge of the component, the component is immersed in etching liquid or treated by steam etching or spray etching.

3. A method as claimed in claim 1, wherein by etching the edge of the component, one or more of the following are removed: excessive sharpness in the edge, bursts in the edge or other irregularities in the edge.

4. A method as claimed in claim 1, wherein the component to be treated by etching is a transmission line for an RF filter.

5. A method as claimed in claim 1, wherein the edge of the component is an edge side or an edge surface of an outer edge of the component.

6. A method as claimed in claim 1, wherein the component to be treated by etching is a cover or a bottom for an RF filter.

7. A method as claimed in claim 1, wherein the edge of the component is an edge rim outlining a through hole located within the area of the component, or an edge surface of the through hole between the edge rims of the through hole in the component around the through hole.

8. A method as claimed in claim 7, wherein the through hole treated by etching and comprising the edge surface forms a fastening point for a resonator of a filter.

9. A method as claimed in claim 1, wherein in order to treat the edge of the component, the RF filter comprising the component is treated by etching.

10. A method as claimed in claim 1, wherein after etching, the component and/or the RF filter comprising the component are cleaned.

11. A method as claimed in claim 10, wherein the cleaning is carried out as ultrasound cleaning.

12. A component for an RF filter, the component being a cover, a bottom, a separating wall, a transmission line made of sheet metal or another component made of sheet metal, wherein the formed component comprises an edge finishing-treated by etching, the edge being an edge side, an edge surface or an edge rim.

13. A component for an RF filter as claimed in claim 12, wherein the edge of the component finishing-treated by etching is the edge side or the edge surface of an outer edge of the component.

14. A component for an RF filter as claimed in claim 12, wherein the edge of the component finishing-treated by etching is an edge rim outlining a through hole located within the area of the component, or an edge surface of the through hole between the edge rims of the through hole in the component around the through hole.

15. An RF filter comprising a component as claimed in claim 12.
